(19) United States
(12) Patent Application Publication
(10) Pub. No.: US 2026/0220231 A1
(43) Pub. Date: Jul. 30, 2026

(54) METHOD FOR DIGITAL FILE PROTECTION

(71) Applicant: DIGIFY PTE LTD, Singapore (SG)

(72) Inventors: Augustine Cheng Ting LIM, Singapore (SG); Ming Tung LAU, Singapore (SG); Nicolas TANVIS, Singapore (SG); Mohammed NAQIB, Singapore (SG)

(21) Appl. No.: 19/038,475

(22) Filed: Jan. 27, 2025

(51) Int. Cl. G06F 21/10; G06F 21/60

(52) U.S. Cl. CPC G06F 21/107; G06F 21/602

(57) ABSTRACT

This disclosure relates to digital file protection, specifically focusing on methods for ensuring continuous protection of files after download using a web-based application. It addresses the need for secure offline access and real-time tracking of downloaded files, enabling file owners to retain control over file access, even when internet connectivity is intermittent or unavailable.

### TECHNICAL FIELD

The description herein relates generally to digital file protection.

### BACKGROUND

In the era of digital file sharing, maintaining control over sensitive files after they are downloaded presents significant challenges. Conventionally, after a file has been shared by a file owner, the recipient (or client) receives full access to the file. The recipient can access the file at any time and is free to share the file with others. After sharing with the recipient, the file owner no longer has control of the shared file, ceding control to the recipient.

While encryption-based solutions exist for transmitting and storing data securely, many fail to maintain encryption and access control after the file has been downloaded, especially when the recipient operates in different environments or devices. Current solutions may also require users to install separate software clients, causing potential security vulnerabilities and user resistance due to installation complexity.

Conventional Digital Rights Management (DRM) and encryption-based solutions are often dependent on continuous internet access for authentication and access verification. This requirement can be impractical for users in low-bandwidth or offline environments. Furthermore, many existing solutions lack real-time tracking and monitoring capabilities for downloaded files, leaving file owners with limited visibility into how files are accessed or used.

### SUMMARY

The disclosure relates to systems and methods for the continuous protection of downloaded files, enabling offline access for a configurable period (such as 72 hours) and real-time tracking through a client-side application. The client-side application may include a web-based application, such as a Progressive Web Application (PWA). A web-based application is an application that executes within a browser. The system may introduce a custom file extension directly associated with the web-based application, allowing recipients to open protected files simply by clicking on them or dragging them onto a designated viewer page within the application. Files are encrypted server-side, with access controlled via a license-based decryption mechanism securely managed and executed within the web browser, eliminating the need for additional software installations.

The system may provide continuous protection of files after they are downloaded. In some examples, the system enables recipients to access protected files while offline, such as for a limited time. Additionally, the system includes real-time tracking capabilities, logging interactions and synchronizing data with a server when internet connectivity is restored. The solution leverages a web-based application framework, allowing it to operate across devices without requiring specialized software installation.

Recipients may be provided with a file that is protected. The file may be protected based on an encryption algorithm, such as a symmetric encryption algorithm that uses a shared key, or an encryption/decryption key, to encrypt the file. Upon download, the protected file remains encrypted. To access the file, the recipient requests a license file from the server, which may include the encryption/decryption key. In some examples, the license file may further include access permissions. The license file may be encrypted based on an asymmetric encryption algorithm that uses a key pair, including a server key and a client key, for encryption and decryption. The license file, when decrypted, provides access to the decryption key that may be used to decrypt the protected file. For instances in which a web-based application is used by the client, the license file allows the recipient to view the decrypted file directly in the browser, without requiring additional third-party software (other than a pre-installed web-based application). The system ensures only authorized browsers can open the file by linking a unique browser fingerprint to the recipient's identity. Both the decryption keys and license files are stored securely within the browser, and all decryption processes occur locally, delivering a seamless and secure experience.

The disclosure leverages symmetric encryption (e.g., AES) for file encryption, while asymmetric encryption (e.g., RSA) secures the license file. The web-based application manages all decryption, license caching for offline access, and interaction tracking. During offline access, the decryption license remains secured in client-side storage within the browser, ensuring protection without exposing sensitive keys outside the secure environment. Offline interactions are cached locally and later synchronized with the server, ensuring continuous monitoring of file usage even without constant internet connectivity.

This system guarantees that only the intended recipient can access the file. If the license expires or if an attempt is made to open the file from an unauthorized browser, access is automatically denied.

According to an embodiment, there is provided a method. The method comprises accessing a file to be encrypted. The method comprises generating an encryption key for the file. The method comprises encrypting the file based on a first encryption algorithm and the encryption key. The method comprises associating the file with a file extension that links the file to a client-side application at a client-side device where the file can be viewed. The method comprises generating a license file comprising the encryption key. The method comprises generating first metadata associated with the license file, the first metadata specifying offline access parameters including an indication of offline access expiration. The method comprises encrypting the license file based on a second encryption algorithm and a server key accessible to the server, the server key being related to a client key, associated with the client-side device, that is used to decrypt the encrypted license file. The method comprises transmitting the license file to the client-side device.

In some embodiments, the method further comprises generating second metadata associated with the encrypted file.

In some embodiments, the second metadata comprises client identification information.

In some embodiments, the generating the second metadata comprises generating the second metadata separately from the encrypted file and sending the second metadata.

In some embodiments, the generating the second metadata comprises generating the second metadata by appending the second metadata to the encrypted file.

In some embodiments, the client-side application is web-based.

According to an embodiment, there is provided a method for protecting a file using an application on a client-side device. The method comprises receiving a file extension of the file and an encrypted license file, the file extension being encrypted based on a first encryption algorithm and an encryption/decryption key and the encrypted license file being encrypted with a server key of a key pair, wherein, the encrypted license file, when decrypted, includes the encryption/decryption key. The method comprises verifying offline access availability based on an offline access expiration. The method comprises decrypting the license file with a client key of the key pair to obtain the encryption/decryption key. The method comprises decrypting the file extension based on the first encryption algorithm and the encryption/decryption key obtained from the decrypted license file.

In some embodiments, the file extension is downloaded by the client-side device.

In some embodiments, the offline access expiration is a duration of time from which the file is first viewed.

In some embodiments, the offline access expiration is an expiration date and time.

In some embodiments, the method further comprises authenticating file access via a unique browser or a device identifier. The method comprises associating a unique identifier with the client-side device. The method comprises verifying the unique identifier upon attempting to open the file. The method comprises blocking access if the unique identifier does not match or if the number of associated identifiers exceeds a set limit. The method comprises allowing the recipient to reset or remove previous identifiers to regain access if necessary.

In some embodiments, the method comprises caching tracking data, including offline interactions, within the local storage of the application. The method comprises synchronizing the cached tracking data with the server-side device once the client-side device reconnects to the internet. The method comprises discarding the cached tracking data if the client-side device does not reconnect during the offline access availability.

In some embodiments, the method further comprises determining, by the client-side device, that the client key and the server key have not been generated. The method further comprises generating, by the client-side device, the server-key client-key pair used for a second encryption. The method further comprises transmitting, by the client-side device, the server-key to a server that provides the encrypted file, wherein the server encrypts the license file based on the server-key to generate the encrypted license file. The method further comprises storing, by the client-side device, the client key for decrypting the encrypted license file.

In some embodiments, the application is a web-based application executing on a browser of the client-side device. The method further comprises generating, by the client-side device, a browser fingerprint associated with the browser. The method further comprises transmitting, by the client-side device, the browser fingerprint to a server that provides the encrypted file, wherein the server uses the browser fingerprint to identify the client-side device for authentication.

In some embodiments, the method further comprises accessing one or more offline access parameters of first metadata from the encrypted license file when the encrypted license file is decrypted. The method further comprises verifying offline access availability based on the offline access parameters.

In some embodiments, the method further comprises accessing one or more client identification parameters of second metadata that were appended to the encrypted file. The method further comprises verifying offline access availability based on the client identification parameters.

### BRIEF DESCRIPTION OF THE DRAWINGS

The accompanying drawings, which are incorporated in and constitute a part of the specification, illustrate one or more embodiments and, together with the description, explain these embodiments. Embodiments of the disclosure will now be described, by way of example only, with reference to the accompanying schematic drawings in which corresponding reference symbols indicate corresponding parts, and in which:

FIG. 1 illustrates a system for digital file protection, according to an embodiment.

FIG. 2A illustrates details of a server, according to an embodiment.

FIG. 2B illustrates details of a client device, according to an embodiment.

FIG. 3 illustrates a flowchart for a file upload process, according to an embodiment.

FIG. 4 illustrates a flowchart for a file download process, according to an embodiment.

FIGS. 5A-5B illustrate a flowchart for a file opening process, according to an embodiment.

FIG. 6 illustrates a flowchart for an offline viewing process, according to an embodiment.

FIG. 7 illustrates an offline tracking process, according to an embodiment.

FIG. 8 illustrates an example of a computer system that may be implemented by devices illustrated in FIG. 1, according to an embodiment.

### DETAILED DESCRIPTION

Digital file protection provides continued protection for the file even after it has been downloaded by the recipient. The disclosure relates to one or more improvements over the existing DRM, or digital rights management, technology.

In some examples, there is no requirement for third-party client software. This disclosure uses a web-based application that is accessible via standard browsers without the need for additional plugins or software installations. The application provides secure encryption, decryption, and access control natively within the browser using a client-side database within the browser for local storage.

In some examples, offline access of the file is granted for a limited duration of time. Traditionally, internet connectivity is required for file access. However, for a configurable duration of time, such as 3 days, the recipient can access the file without internet access. This is done by caching a license in a browser-based client-side storage.

In some examples, device and browser control via unique identifiers is provided. In the past, file access generally relied on device-based or account-based access, which can require specific hardware setups or user accounts. On the other hand, this disclosure verifies user identity through a unique device or browser identifier, such as a browser fingerprint, providing flexibility and supporting access control without tying it to specific hardware. This allows for broader device compatibility while maintaining secure access limitations.

In some examples, real-time and offline tracking of file interactions is provided. By incorporating a tracking and analytics module that logs file access details, offline tracking data is cached in the client-side storage and synced to the server when the user reconnects, allowing file owners to monitor access patterns, locations, and devices even when the files are used offline.

In some examples, a decryption license for offline use is cached. By storing the decryption license in a client-side browser database for offline use, recipients can access files without needing to continually validate permissions online. License expiration is managed through time-based parameters, maintaining control while providing uninterrupted offline access.

In some examples, configurable data retention for offline tracking is provided. This disclosure retains offline tracking data for a configurable period (e.g., 7 days) and synchronizes it with the server when the recipient reconnects. Cached tracking data is discarded if the user does not reconnect within this period, providing flexibility while ensuring offline activity is monitored when possible.

In some examples, there is cross-platform compatibility via a web-based application. In traditional DRM, there is often limited to specific platforms or devices, relying on compatible DRM hardware or software. However, this disclosure uses a web-based application framework for cross-platform compatibility, allowing the solution to work across various modern browsers and devices without dependency on specific DRM hardware or operating systems. PWAs, or progressive web apps, are a compatible example, but the disclosure applies broadly to any web-based approach.

In some examples, web-based encryption can be implemented independent of hardware requirements. While many DRM systems use standard encryption protocols (e.g., AES for content encryption and RSA for key management), they often depend on hardware-based modules or software client installations to manage encryption and decryption, limiting flexibility across platforms. On the other hand, this disclosure implements standard symmetric and asymmetric encryption protocols directly within the web-based application environment, without requiring specialized hardware or dedicated software. This approach leverages standard web cryptographic capabilities, making it easily deployable across diverse platforms and devices while maintaining strong encryption.

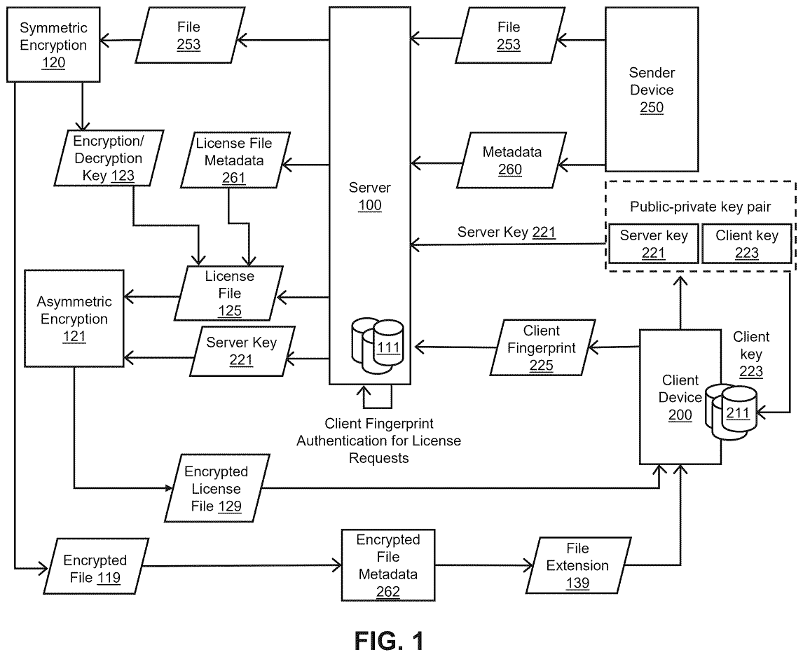

FIG. 1 illustrates a system for digital file protection, according to an embodiment. A sender, or file owner, has a file 253 that they want to share. Using a sender device 250, the sender uploads the file 253 along with metadata 260 to the server 100. The metadata 260 comprises license file metadata (or first metadata) 261 and encrypted file metadata (or second metadata) 262.

In this example, the license file metadata 261 comprises access parameters, and the encrypted file metadata 262 comprises client identification information, or user IDs. However, the disclosure is not limited to this. The license file metadata 261 can comprise user IDs, and the encrypted file metadata 262 can comprise access parameters. Alternatively, both access parameters and user IDs can be comprised within the license file metadata 261 or the encrypted file metadata 262. As a further alternative, both access parameters and user IDs can be in both the license file metadata 261 and the encrypted file metadata 262.

The access parameters of the license file metadata 261 specify whether file protection is enabled and offline access parameters. For example, the offline access parameters include the duration that the client can view the file while offline.

The client identification information of the encrypted file metadata 262 provide a list of all the users who have access to the document. The client identification information can comprise, for example, globally unique identifiers (GUIDs) and user IDs.

The sender device 250 may comprise a computer, phone, or other type of network-connected device. The sender device 250 may run an application to upload the file 253 to the server 100. The application may be a web-based application, which is an application that executes within a web browser. An example of a web-based application is a progressive web application (PWA). A PWA is an app that uses web platform technologies.

The file 253 undergoes symmetric encryption 120 with an encryption/decryption key (or shared key) 123. For symmetric encryption 120, the same key, which is the shared key 123 in this case, is used for both encryption and decryption. The shared key 123 is used as an encryption key in symmetric encryption 120 for encrypting the file 253. The result is an encrypted file 119. The encrypted file 119 will be appended by encrypted file metadata 262 to create file extension 139. The custom file extension 139 comprises the encrypted file 119 with the appended encrypted file metadata 262. In this example, the file extension 139 may be an encrypted DGF file. The encrypted file metadata 262 comprises the client identification information.

A client device 200 has been authorized to access the file 253. Using the web-based application, the client device 200 provides a client fingerprint 225 to authenticate the user. Thereafter, the server 100 provides an encrypted file 119 to the client device 200.

The client device 200 also creates a public-private key pair comprising a server key (or public key) 221 and a client key (or private key) 223. The server key 221 is transmitted to the server 100. The server creates a license file 125 that encrypts the encryption/decryption key 123 with the server key 221 using asymmetric encryption 121. The license file also comprises the license file metadata 261. The license file metadata 261 includes the access parameters. Thereafter, the encrypted license file 129 is sent to the client device 200.

Using the client key 223 that it previously created, the client device 200 decrypts the encrypted license file 129, which reveals the encryption/decryption key 123. The shared key 123, which is now used as a decryption key, then decrypts the file extension 139. As such, the decrypted file can then be viewed on the client device 200.

It is noted that each file has a unique randomly generated key. On the other hand, there is only one public-private key pair that is used between the server 100 and a client device 200. A different client device will have its own unique public-private key pair with the server 100.

A server storage 111 comprises a storage S3 and databases (not shown). The storage S3 of the server storage 111 stores the file 253, the encrypted file 119, the file extension 139, the license file 125, and the encrypted license file 129. The databases store the license file metadata 261, the client fingerprint 225, the encryption/decryption key 123, and the server key 221.

A client storage 211 stores the client fingerprint 225, the file extension 139, the encrypted license file 129, and the client key 223.

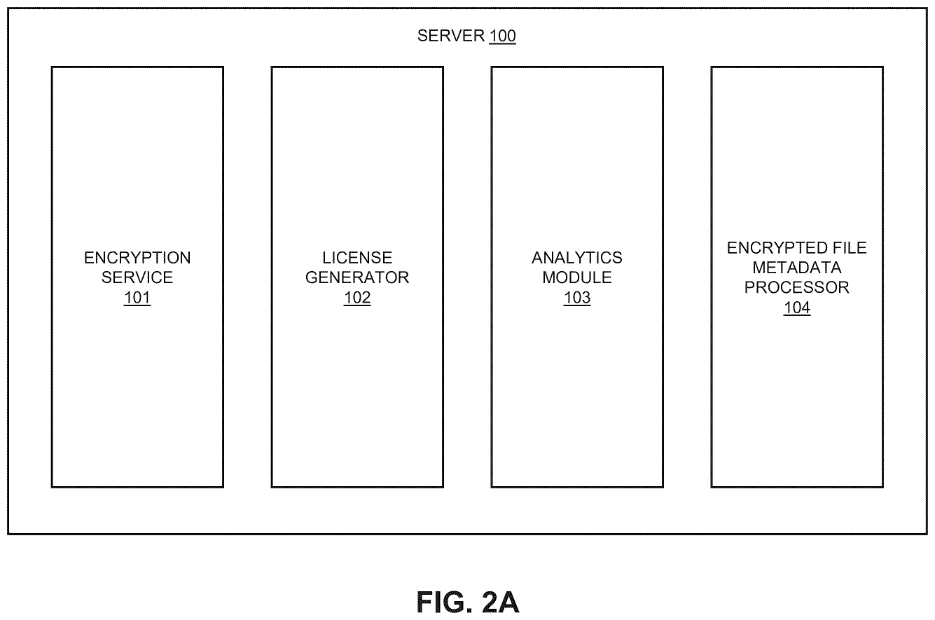

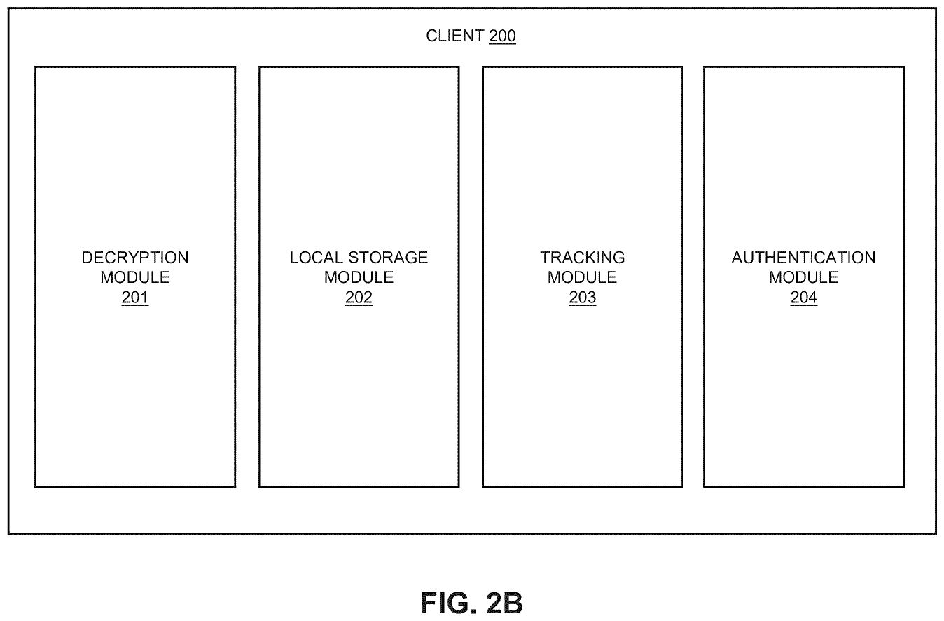

Digital file protection requires system components on both the server-side and client-side. FIG. 2A illustrates details of the server 100, according to an embodiment. On the server-side, an encryption service 101 encrypts uploaded files 253 using a symmetric encryption 120 algorithm (e.g., AES) and generates a unique encryption/decryption key 123 for each file. Symmetric encryption 120 uses the same cryptographic key 123 for both encryption and decryption, hence the name shared key. Symmetric encryption algorithms include AES, RC4, DES, and Twofish. These algorithms or any other can be used for this symmetric encryption. In this example, the encryption/decryption key 123 is used both to encrypt the file 253 and decrypt the file extension 139. As a result, the encryption/decryption key 123 must be securely transmitted to the client device 200 in order to decrypt and view the file extension 139.

A license generator 102 is required to create the license file 125 containing the encryption/decryption key 123 and license file metadata 261. This license file is encrypted using an asymmetric encryption algorithm (e.g., RSA) before being transmitted to the recipient. Asymmetric encryption, or public-key encryption, uses a pair of related keys to encrypt and decrypt a message. Asymmetric encryption algorithms include RSA, DSS, YAK, and Diffie-Hellman, any of which can be used. Alternatively, other asymmetric encryption methods can be applied.

A tracking and analytics module 103 logs file access information, including offline interactions, and syncs data from recipients when connectivity is restored. Further, an encrypted file metadata processor 104 is used to add the encrypted file metadata 262 to each file, including client identification information. The encrypted file metadata 262 can be appended to the file, or it can be created separately from the file.

FIG. 2B illustrates details of the client device 200, according to an embodiment. The client device 200 may comprise a computer, phone, or other type of network-connected device. The client device 200 runs a web-based application. A web-based application is an application that executes within a web browser. An example of a web-based application is a progressive web application (PWA). A PWA is an app that uses web platform technologies.

The client-side device 200 may comprise the following components. A decryption module 201 retrieves the shared key 123 from the decrypted license file 129 and uses it as a decryption key to decrypt the file 139 within the application. A local storage module 202 caches the license file 125 in a client-side database within the browser, allowing offline access for a specified duration. The local storage module 202 is part of the client storage 211. A tracking module 203 logs file interactions, including offline access, and syncs this data with the server 100 when internet connectivity is available. An authentication module 204 verifies the client's identity through the client fingerprint 225. Any other type of identification authentication can be applied, such as a password, biometric information, a code, or a combination of the above.

Next, the process of digital file protection will be described.

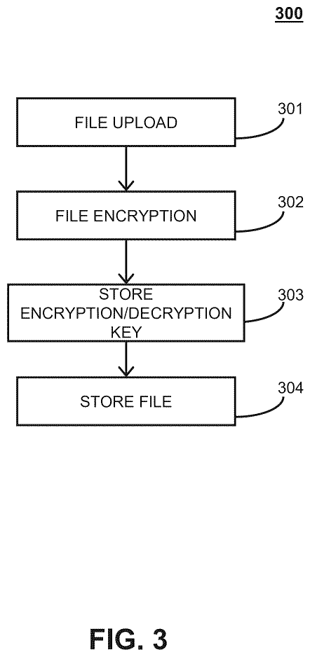

FIG. 3 illustrates a flowchart for a file upload process 300, according to an embodiment. The file owner, or sender, first uploads a file 253 to a server 100 using a sender device 250 with the protection option enabled, corresponding to a file upload step 301. Enabling protection can be as simple as checking a box or filling in a radio button. By selecting this option, the server 100 encrypts the file 253 using a symmetric encryption 120 algorithm. This is performed in the file encryption step 302. A randomly generated encryption/decryption key 123, which is used to decode the symmetric encryption 120 algorithm, is stored securely on the server 100. This is done in the store encryption/decryption key step 303. The encrypted file 119 is then stored in cloud storage on the server 100 and made available to download by authorized recipients. This is performed in the store file step 304.

Each file 253 is encrypted with a respective unique file encryption key 123. Files do not share encryption keys; rather, each file has a separate encryption key. The file encryption key 123 is saved to the server database. Further, an authentication tag will be prepended to the encrypted file 119, not saved to the database. The file encryption that can be used is the AES-GCM system. However, this is not limiting; other types of cryptography systems can also be applied, such as AES-256-GCM, ChaCha, AEGIS, or AES-GCM-SST.

Further, the offline access parameters can include a time duration, an expiration date, and/or other indication of offline access expiration. For example, an offline access parameter may include a time duration (such as 72 hours) after a triggering event such as a file access. Alternatively, or additionally, the offline access parameters may include an expiration date that includes a date and/or time at which offline access expires. In a preferred embodiment, the offline access parameters includes a time duration for file accessibility.

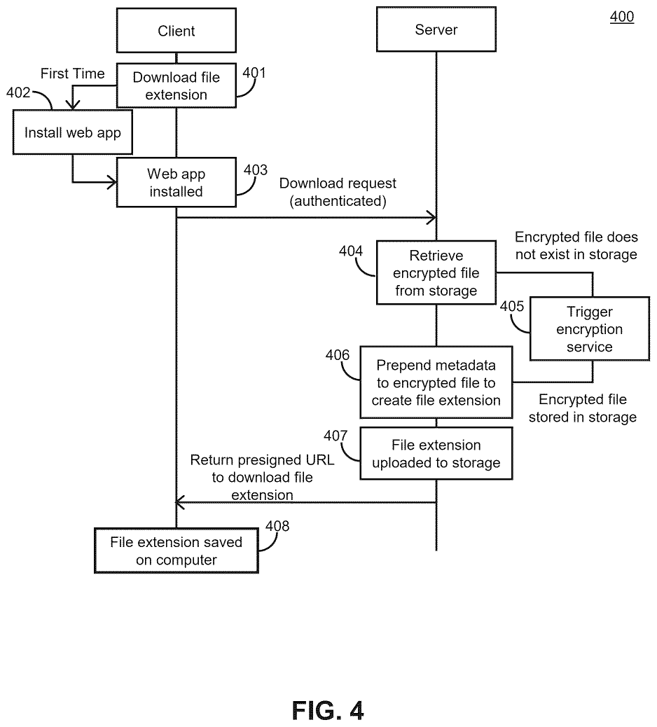

FIG. 4 illustrates a flowchart for a file download process 400, according to an embodiment. After file 253 upload by the file owner, the client (or recipient) has the capability of downloading the file. The recipient requests download of the file extension 139. This is performed in the download file step 401. The file extension 139 in this example is a DGF file, but the disclosure is not limited to this. Any other type of file, such as a document, video, or audio, can also be downloaded. If this is the client's first time using the web-based application, such as a PWA, then the application will first be installed. Step 402 shows the installation of the web-based application. Thereafter, the chart proceeds to step 403, which shows that the web-based application has been installed. Both previous users and new users will then move on to submit a download request via an HTTPS secure site. First, user authentication is required. This can be in the form of a password or a biometric identification. Once authentication of the user is complete, the server 100 side will begin to act. The server 100 will first retrieve the encrypted file 119 from the storage S3 (step 404). If the encrypted file 119 is not found in the server storage S3, the encryption service 101 will then be triggered (step 405) to perform encryption on the file 253. Once the file 253 has been encrypted and stored in the storage S3 as the encrypted file 119, then the encrypted file metadata 262 can be appended to the encrypted file 119 (step 406). The encrypted file metadata 262 can be appended to the file or created distinctly and provided separately from the file. This creates the file extension 139. Alternatively, other file types can be used. File types that can be used include documents, videos, audio, and others that can be supported by the browser or natively available. When other file types are used, a separate metadata file is created that is sent with the file. Therefore, the file extension 139 is uploaded to the server storage S3 (step 407). The secure site will then return a URL for downloading the file extension 139. As result, the client can download the file extension 139 and save it on their computer (step S408).

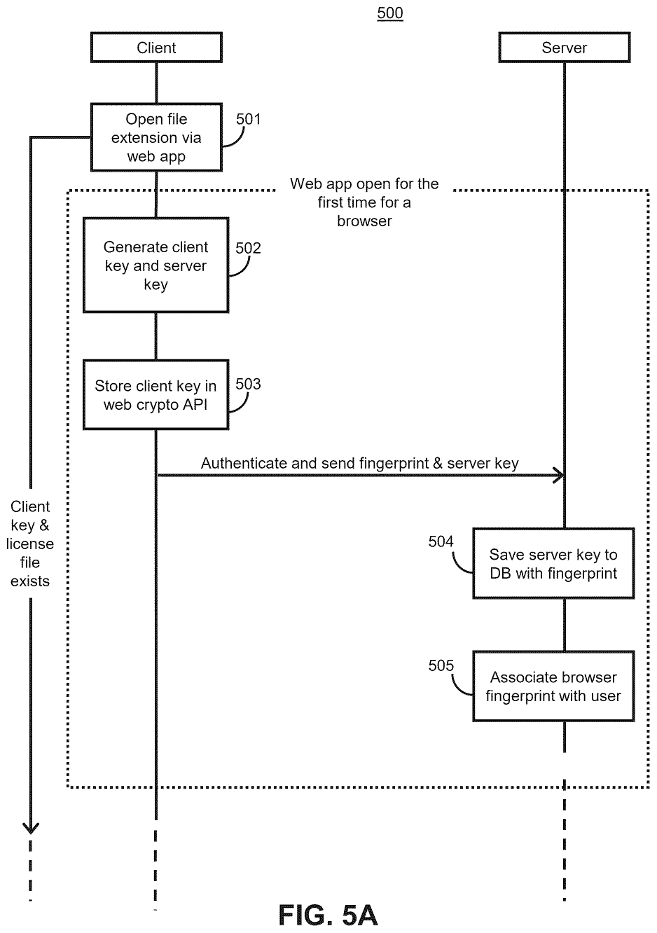

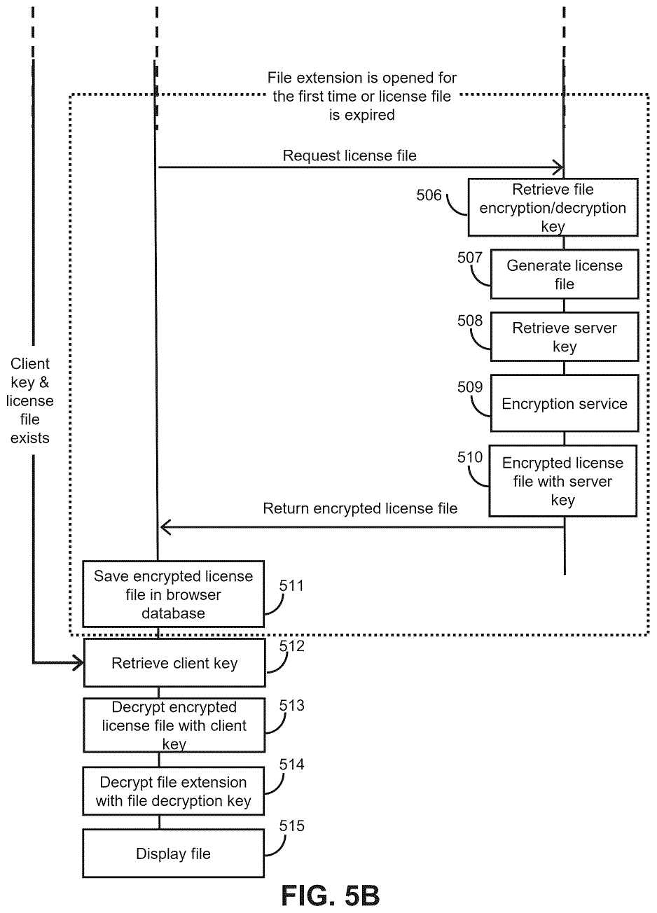

FIGS. 5A-5B illustrate a flowchart for a file opening process 500, according to an embodiment. FIG. 5A illustrates the first half of the flowchart. In order for the client to open the file extension 139, there are many steps that are performed in the background. First, the client opens the file extension 139 via the web-based application (step 501). If the client key 223 and the license file 125 do not yet exist, then initialization must be performed. This only occurs the first time that the user opens the web-based application for a web browser. Step 502 generates the client key 223, which is used only by the client, and the server key 123, which is used only by the server 100, on the client side. Each client has a pair of client and server keys per browser. The client key 223, which is the asymmetric decryption key, is stored in web crypto API, as seen in step 503. The client then authenticates and sends fingerprints (or a password) and a server key 221 to the server. On the server side, the server key 221 and the fingerprints are saved in the server database (step 504). The server key 221 is the asymmetric encryption key. Further, the server 100 then associates the fingerprints with the client (step 505).

FIG. 5B illustrates the second half of the flowchart. After initialization, there is the situation where a file extension 139 is opened for the first time or the license file 125 has expired. In these cases, the client will request for the license file 125 from the server 100. The server 100 will first retrieve the file encryption/decryption key 123 (step 506). Next, the server will generate a license file 125 in step 507. The license file includes the file encryption/decryption key 123 and license file metadata 261. Following this, the server 100 retrieves the server key 221 (step 508). Then the license file 125 and the server key 221 will be encrypted using the encryption service 101 (step 509). Once encrypted, the encrypted license file 129 with the server key 221 are now ready to be passed over to the client side (step 510). The license file 125 is encrypted using RSA with a server key 221. However, other encryption methods are also possible. Thereafter, the encrypted license file 129 is sent to the client. On the client side, the encrypted license file 129 is saved in a browser database (step 511). An example of a browser database is IndexedDB. At this point, browser setup and license file transfer are now complete.

For the client who already has used the browser for the application in the past and has a valid license fee, these would now be retrieved. The client key 223 is stored in web crypto API and reference is stored in the browser database.

Both new users and returning users converge in the flowchart at step 512. Step 512 is a step of retrieving the client key 223. The client key 223 is necessary to decrypt the encrypted license file 129, seen in step 513. This decryption is performed by RSA with the client key 223. The method of decrypting the encrypted license file 129 is not limited to this. Other types of encryption methods can be used. Decrypting the encrypted license file 129 reveals the file encryption/decryption key 123. The file decryption key 123 is then used to decrypt the file extension 139 (step 514). Finally, the file is displayed (step 515). The file is displayed using the application on a web browser.

On the server-side storage, there is both storage S3 and databases. The storage S3 contains the original file 253, the encrypted file 119, and the file extension 139. A first database includes the file encryption/decryption keys 123. A second database includes the server key 221.

On the client side, information is stored in different locations. The client key 223 is stored in web crypto API. The browser database stores the web-based application installation flag, the encrypted license file 129, the client key reference, the server key saved flag, the last access time, and the last viewed page. Information that is stored in local storage includes fingerprint data in plain text.

The license file data structure is comprised of a base64-encoded string, followed by the expiration of the license file, the email of the client, and last a watermark.

Further, if offline access is enabled, the encrypted license file 129 is stored locally in a client-side database within the browser and configured to expire after a predefined period. This allows for the capability to open the file even without internet connectivity.

Moreover, the custom file extension 139 streamlines file access by automatically linking the protected file format with the web-based application, facilitating a seamless click-to-open or drag-and-drop user experience.

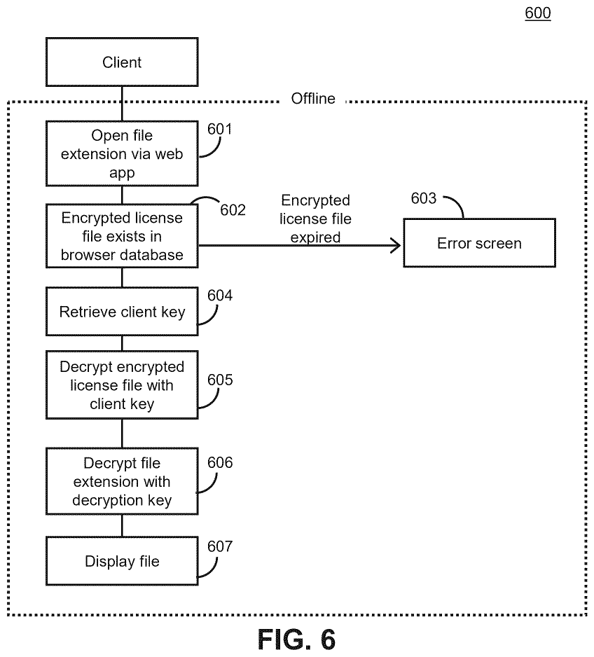

FIG. 6 illustrates a flowchart for an offline viewing process 600, according to an embodiment. In step 601, the client opens the file extension 139 via the web-based application in an offline environment. Prior to being offline, the encrypted license file 129 is stored locally. Offline access must be enabled prior to losing internet connectivity in order for the encrypted license file 129 to be stored on the client-side device 200. In step 602, the encrypted license file 129 in the browser database is retrieved. If the encrypted license file 129 has expired, then an error screen will be displayed (step 603). The file will not be accessible to the client if the encrypted license file 129 is no longer valid. The license file expiration duration is configurable. In a preferred embodiment, the encrypted license file 129 expires 72 hours after creation. However, any length of time can be chosen. For example, the license file expiration can be as little as 5 hours or as long as 1 month.

Offline access is available for a configurable time duration, after which the recipient must reconnect to the server to renew access. Further, the offline access expiration can be expressed either in a time duration (e.g., 72 hours) or an expiration date (e.g., Jan. 1, 2025 at 12 AM). If the offline period expires, the file remains encrypted, and the file cannot be access until revalidation occurs.

Once it has been determined that the encrypted license file 129 has not yet expired, then the client key 223 is retrieved (step 604). Even without network access, the client key 223 cached in the local storage allows the recipient to open and view the file. The client key 223 is then used to decrypt the encrypted license file 129 in step 605. In this example, the decryption uses RSA with a client key. However, the decryption is not limited to this. Other decryption methods within cryptography can be used. Decrypting the encrypted license file 129 will reveal the file encryption/decryption key 123. The file decryption key 123 is then used to decrypt the file extension 139 (step 606). Thereafter, the file is displayed on the web-based application in an offline setting (step 607).

Other offline access parameters can also be set. There can be a set limit to the number of times the file can be opened while offline. For example, the file cannot be opened more than 20 times while offline prior to reconnecting. There can also be a max duration logic to further ensure that the file does not exceed the offline time limit.

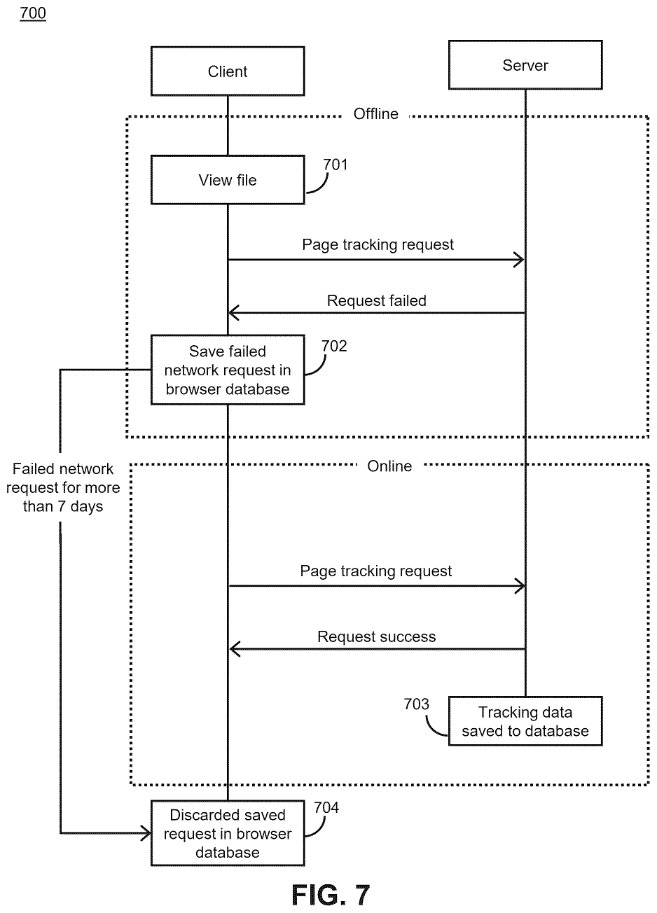

FIG. 7 illustrates an offline tracking process 700, according to an embodiment. In step 701, the client is viewing the file in an offline environment. Page tracking requests are initiated by the server, but because the client does not have internet connectivity, the request fails. As a result, the failed network request is saved, along with the tracking data, in the browser database (step 702). The tracking module 203 of the web-based application (which may execute on the client-side device 200) logs all file interactions, including time, location, device, and browser or application details. Anytime that the file is open, the tracking module 203 will record details of the event. When the recipient accesses the file offline, all interactions are cached in the local storage.

Subsequently, when the client returns online, the tracking data is successfully saved to the server database (step 703). The page tracking request is a background sync event that does not require client involvement. The cached tracking data is synchronized with the server 100. Upon synchronization, the data from the tracking module 203 is sent to the tracking and analytics module 103 of the server 100. Further, tracking data is retained locally for a configurable period (e.g., 7 days), after which the data is discarded the browser database is discarded (step 704).

While a web-based application that is browser embedded has been described, the disclosure is not limited to this. Any client application can be used.

The application securely manages cryptography keys. Specifically, the cryptographic key object, which references an internal slot as described in the specification, is securely stored. This ensures that the underlying key material is securely isolated and inaccessible directly.

Additionally, the keys generated by the application are designed to be non-exportable, as supported by the underlying cryptographic implementation. This non-exportability guarantees that even if an attacker gains access to the key reference, they cannot extract or use the key outside the controlled environment.

It is also possible to store files without enabling protection. By not checking the box, these files will also be stored in the storage but will be accessible by conventional download. These files can be open in the application but will not be encrypted, unlike the protected files. As a result, both protected and conventional files can be stored on the server and accessed by authorized users. The only difference is file encryption.

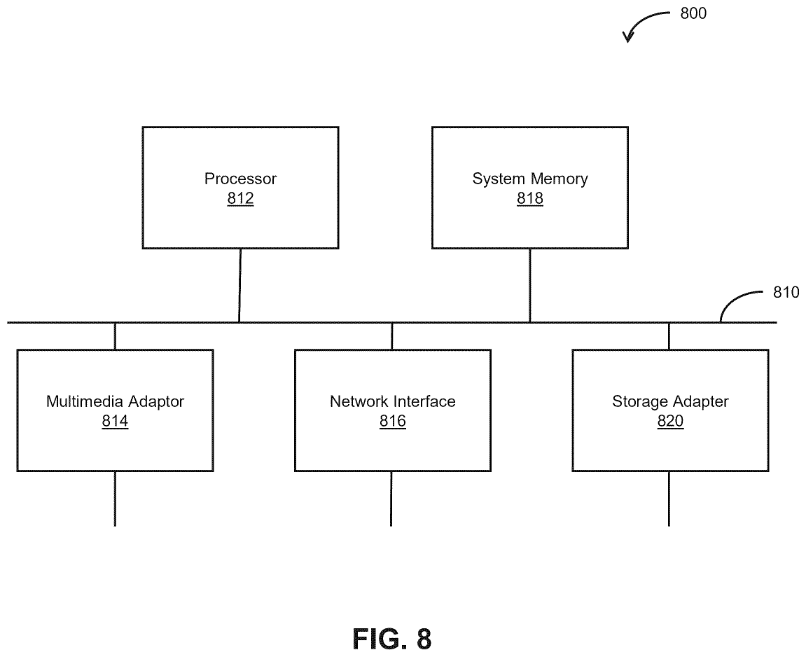

FIG. 8 illustrates an example of a computer system 800 that may be implemented by devices illustrated in FIG. 1, according to an embodiment. The computer system 800 may be part of or include the server 100 to perform the functions and features described herein. For example, various ones of the devices of server 100 may be implemented based on some or all of the computer system 800. The computer system 800 may include, among other things, an interconnect 810, a processor 812, a multimedia adapter 814, a network interface 816, a system memory 818, and a storage adapter 820.

The interconnect 810 may interconnect various subsystems, elements, and/or components of the computer system 800. As shown, the interconnect 810 may be an abstraction that may represent any one or more separate physical buses, point-to-point connections, or both, connected by appropriate bridges, adapters, or controllers. In some examples, the interconnect 810 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 810 may allow data communication between the processor 812 and system memory 818, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 812 may control operations of the computer system 800. In some examples, the processor 812 may do so by executing instructions such as software or firmware stored in system memory 818 or other data via the storage adapter 820. In some examples, the processor 812 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 814 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 816 may provide the computer system 800 with an ability to communicate with a variety of remote devices over a network. The network interface 816 may include, for example, an Ethernet adapter, a Fibre Channel adapter, and/or other wired- or wireless-enabled adapter. The network interface 816 may provide a direct or indirect connection from one network element to another, and facilitate communication to and between various network elements. The storage adapter 820 may connect to a standard computer readable medium for storage and/or retrieval of information, such as a fixed disk drive (internal or external).

Other devices, components, elements, or subsystems (not illustrated) may be connected in a similar manner to the interconnect 810 or via a network. The devices and subsystems can be interconnected in different ways from that shown in FIG. 8. Instructions to implement various examples and implementations described herein may be stored in computer-readable storage media such as one or more of system memory 818 or other storage. Instructions to implement the present disclosure may also be received via one or more interfaces and stored in memory. The operating system provided on computer system 800 may be MS-DOS®, MS-WINDOWS®, OS/2®, OS X®, IOS®, ANDROID®, UNIX®, Linux®, or another operating system.

Various embodiments of the present systems and methods are disclosed in the subsequent list of numbered clauses:
1. A method, comprising: accessing a file to be encrypted; generating an encryption key for the file; encrypting the file based on a first encryption algorithm and the encryption key; associating the file with a file extension that links the file to a client-side application at a client-side device where the file can be viewed; generating a license file comprising the encryption key; generating first metadata associated with the license file, the first metadata specifying offline access parameters including an indication of offline access expiration; encrypting the license file based on a second encryption algorithm and a server key accessible to the server, the server key being related to a client key, associated with the client-side device, that is used to decrypt the encrypted license file; and transmitting the license file to the client-side device, wherein the encrypted license file is to be decrypted by the client-side device, to obtain the encryption key to decrypt the encrypted file, using the private key until offline access to the encrypted file is available as specified by the indication of offline access expiration.
2. The method of any of the previous clauses, further comprising generating second metadata associated with the encrypted file.
3. The method of any of the previous clauses, wherein the second metadata comprises client identification information.
4. The method of any of the previous clauses, wherein the generating the second metadata comprises generating the second metadata separately from the encrypted file and sending the second metadata.
5. The method of any of the previous clauses, wherein the generating the second metadata comprises generating the second metadata by appending the second metadata to the encrypted file.
6. The method of any of the previous clauses, wherein the client-side application is web-based.
7. A method for protecting a file using an application on a client-side device, comprising: receiving a file extension of the file and an encrypted license file, the file extension being encrypted based on a first encryption algorithm and an encryption/decryption key and the encrypted license file being encrypted with a server key of a key pair, wherein, the encrypted license file, when decrypted, includes the encryption/decryption key; verifying offline access availability based on an offline access expiration; decrypting the license file with a client key of the key pair to obtain the encryption/decryption key; and decrypting the file extension based on the first encryption algorithm and the encryption/decryption key obtained from the decrypted license file.
8. The method of any of the previous clauses, wherein the file extension is downloaded by the client-side device.
9. The method of any of the previous clauses, wherein the offline access expiration is a duration of time from which the file is first viewed.
10. The method of any of the previous clauses, wherein the offline access expiration is an expiration date and time.
11. The method of any of the previous clauses, further comprising authenticating file access via a unique browser or a device identifier, comprising: associating a unique identifier with the client-side device; verifying the unique identifier upon attempting to open the file; blocking access if the unique identifier does not match or if the number of associated identifiers exceeds a set limit; and allowing the recipient to reset or remove previous identifiers to regain access if necessary.
12. The method of any of the previous clauses, further comprising: caching tracking data, including offline interactions, within the local storage of the application; synchronizing the cached tracking data with the server-side device once the client-side device reconnects to the internet; and discarding the cached tracking data if the client-side device does not reconnect during the offline access availability.
13. The method of any of the previous clauses, further comprising: determining, by the client-side device, that the client key and the server key have not been generated; generating, by the client-side device, the server-key client-key pair used for a second encryption; transmitting, by the client-side device, the server-key to a server that provides the encrypted file, wherein the server encrypts the license file based on the server-key to generate the encrypted license file; and storing, by the client-side device, the client key for decrypting the encrypted license file.
14. The method of any of the previous clauses, wherein the application is a web-based application executing on a browser of the client-side device, further comprising: generating, by the client-side device, a browser fingerprint associated with the browser; and transmitting, by the client-side device, the browser fingerprint to a server that provides the encrypted file, wherein the server uses the browser fingerprint to identify the client-side device for authentication.
15. The method of any of the previous clauses, further comprising: accessing one or more offline access parameters of first metadata from the encrypted license file when the encrypted license file is decrypted; and verifying offline access availability based on the offline access parameters.
16. The method of any of the previous clauses, further comprising: accessing one or more client identification parameters of second metadata that were appended to the encrypted file; and verifying offline access availability based on the client identification parameters.

The descriptions above are intended to be illustrative, not limiting. Thus, it will be apparent to one skilled in the art that modifications may be made as described without departing from the scope of the claims set out below.

What is claimed is:

1. A method, comprising:
accessing a file to be encrypted;
generating an encryption key for the file;
encrypting the file based on a first encryption algorithm and the encryption key;
associating the file with a file extension that links the file to a client-side application at a client-side device where the file can be viewed;
generating a license file comprising the encryption key;
generating first metadata associated with the license file, the first metadata specifying offline access parameters including an indication of offline access expiration;
encrypting the license file based on a second encryption algorithm and a server key accessible to the server, the server key being related to a client key, associated with the client-side device, that is used to decrypt the encrypted license file; and
transmitting the license file to the client-side device.

2. The method of claim 1, further comprising generating second metadata associated with the encrypted file.

3. The method of claim 2, wherein the second metadata comprises client identification information.

4. The method of claim 3, wherein the generating the second metadata comprises generating the second metadata separately from the encrypted file and sending the second metadata.

5. The method of claim 3, wherein the generating the second metadata comprises generating the second metadata by appending the second metadata to the encrypted file.

6. The method of claim 1, wherein the client-side application is web-based.

7. A method for protecting a file using an application on a client-side device, comprising:
receiving, by the client-side device, a file extension of the file and an encrypted license file, the file extension being encrypted based on a first encryption algorithm and an encryption/decryption key and the encrypted license file being encrypted with a server key of a key pair, wherein, the encrypted license file, when decrypted, includes the encryption/decryption key;
verifying, by the client-side device, offline access availability based on an offline access expiration;
decrypting, by the client-side device, the license file with a client key of the key pair to obtain the encryption/decryption key; and
decrypting, by the client-side device, the file extension based on the first encryption algorithm and the encryption/decryption key obtained from the decrypted license file.

8. The method of claim 7, wherein the file extension is downloaded by the client-side device.

9. The method of claim 7, wherein the offline access expiration is a duration of time from which the file is first viewed.

10. The method of claim 7, wherein the offline access expiration is an expiration date and/or time.

11. The method of claim 7, further comprising authenticating file access via a unique browser or a device identifier, comprising:
associating a unique identifier with the client-side device;
verifying the unique identifier upon attempting to open the file;
blocking access if the unique identifier does not match or if the number of associated identifiers exceeds a set limit; and
allowing the recipient to reset or remove previous identifiers to regain access if necessary.

12. The method of claim 7, further comprising:
caching tracking data, including offline interactions, within the local storage of the application;
synchronizing the cached tracking data with the server-side device once the client-side device reconnects to the internet; and
discarding the cached tracking data if the client-side device does not reconnect during the offline access availability.

13. The method of claim 7, further comprising:
determining, by the client-side device, that the client key and the server key have not been generated;
generating, by the client-side device, the server-key client-key pair used for a second encryption;
transmitting, by the client-side device, the server-key to a server that provides the encrypted file, wherein the server encrypts the license file based on the server-key to generate the encrypted license file; and
storing, by the client-side device, the client key for decrypting the encrypted license file.

14. The method of claim 7, wherein the application is a web-based application executing on a browser of the client-side device, further comprising:
generating, by the client-side device, a browser fingerprint associated with the browser; and
transmitting, by the client-side device, the browser fingerprint to a server that provides the encrypted file, wherein the server uses the browser fingerprint to identify the client-side device for authentication.

15. The method of claim 7, further comprising:
accessing one or more offline access parameters of first metadata from the encrypted license file when the encrypted license file is decrypted; and
verifying offline access availability based on the offline access parameters.

16. The method of claim 7, further comprising:
accessing one or more client identification parameters of second metadata that were appended to the encrypted file; and
verifying offline access availability based on the client identification parameters.
